(19) United States
(12) Patent Application Publication
(10) Pub. No.: US 2014/0292576 A1
(43) Pub. Date: Oct. 2, 2014

(54) METHOD FOR DETECTING SIGNALS INTENDED AS A DECOY FOR A RECEIVER OF SIGNALS FROM A SATELLITE NAVIGATION SYSTEM AND ASSOCIATED RECEIVER

(71) Applicant: THALES, Neuilly-Sur-Seine (FR)

(72) Inventors: Nicolas Martin, Bourg Les Valence (FR); Jean-Michel Perre, St. Peray (FR); Vincent Chopard, Tournon Sur Rhone (FR)

(73) Assignee: THALES, Neuilly-Sur-Seine (FR)

(21) Appl. No.: 14/226,049

(22) Filed: Mar. 26, 2014

(30) Foreign Application Priority Data
Mar. 27, 2013 (FR) 1300712

(51) Int. Cl. G01S 19/21

(52) U.S. Cl. CPC G01S 19/215
USPC 342/357.59

(57) ABSTRACT

Method for detecting signals intended as a decoy for a receiver of signals from a satellite navigation system, the receiver being equipped with an antenna using controlled reception pattern sensors, comprising the following steps consisting in, for each satellite:
calculating (1) the position of the satellite in a first TGL reference frame centred on the receiver based on the position of the receiver and on the position of the satellite;
determining (2) the attitude of the antenna in the first reference frame;
calculating (3) first elevation and azimuthal angles of the satellite in a second reference frame linked to the antenna, starting from the position of the satellite in the first reference frame and from the attitude of the antenna in the first reference frame;
determining (4) second elevation and azimuthal angles of the satellite in the second reference frame, by iterative search for a maximum of a weighted complex sum of the demodulated signals received by the antenna;
calculating (5) the value of a likelihood function between the first elevation and azimuthal angles of the satellite and the second elevation and azimuthal angles of the satellite; and
detecting (6) a risk of receiving decoy signals when the said value of the likelihood function is lower than a threshold.

The present invention relates to a method and system for detecting decoy signals for a satellite navigation system from signals received by a receiver equipped with a controlled reception pattern antenna array.

Radio-navigation by satellites allows the position of a receiver to be obtained by a solution akin to triangulation, using the pseudo-distances measured from the signals sent by the satellites.

Civilian signals emitted by the satellites are predictable and hence reproducible. This represents a threat for the users because it is consequently possible to generate pirate or decoy signals resembling the signals from the satellites. When a receiver locks onto it, it would then measure an erroneous position, which could have serious consequences in the case of an aircraft.

Several methods are known for detecting an attempt to mask satellite signals or decoy signal.

One method consists in detecting any similarity on the profiles of signal-to-noise ratios measured on the satellite signals. This method only works in environments with obstacles generating attenuations, masking and multiple spurious paths, such as in an urban area. Furthermore, if the decoy signals are modulated according to time profiles different from the powers of each satellite signal generated, then the detection will not see anything.

Another method consists in using the difference in Doppler effect as a function of the directions of arrival of the satellite signals. If the Doppler effects are not coherent with the speed estimated by the receiver, then a decoy is detected. However, it is easy for the decoy device to generate signals yielding coherent Doppler effect measurements in the receiver. The latter then measures an erroneous position and speed without seeing any incoherence in the measurements.

The use of a multi-sensor antenna array allows the directions of arrival of the signals to be measured by virtue of the phase differences and allows it to be verified that they are coherent with respect to the positions of the satellites and to the attitude of the antenna assumed to be known. According to the prior art, the latter method uses a separate signal processing between the sensors and does not benefit from the redundancy of the signals in order to improve the robustness of the demodulation.

One aim of the invention is to overcome this drawback.

According to one aspect of the invention, a method is provided for detecting signals intended to deceive a receiver of signals from a satellite navigation system, the receiver being equipped with an antenna using a controlled reception pattern sensor array, comprising the following steps consisting in, for each satellite:
calculating the position of the satellite in a first TGL reference frame centred on the receiver from the position of the receiver and from the position of the satellite;
determining the attitude of the antenna in the first reference frame;
calculating first elevation and azimuthal angles of the satellite in a second reference frame linked to the antenna, starting from the position of the satellite in the first reference frame and from the attitude of the antenna in the first reference frame;
determining second elevation and azimuthal angles of the satellite in the second reference frame, by an iterative search for a maximum of a weighted complex sum of the demodulated signals received by the antenna;
calculating the value of a likelihood function between the first elevation and azimuthal angles of the satellite and the second elevation and azimuthal angles of the satellite; and
detecting a risk of receiving decoy signals when the said value of the likelihood function is lower than a threshold.

Such a method therefore allows the detection of signals emitted with the aim of deceiving the receiver of signals from a satellite navigation system to be greatly improved and serious consequences for the user of the receiver to thus be avoided, notably in the case of an aircraft.

In one embodiment, the said iterative search for a maximum of a weighted complex sum of the demodulated signals received by the antenna is carried out using an elevation angle discriminator and an azimuthal angle discriminator.

Thus, the method allows the robustness to scrambling or scrambling or interference to be improved thanks to the redundancy of the sensors of the antenna.

According to one embodiment, the step for determining the attitude of the antenna in the first reference frame uses data supplied by an inertial reference.

The attitude may thus not be the object of a decoy attempt.

In one embodiment, the step for determining the attitude of the antenna in the first reference frame uses the said determination of the second elevation and azimuthal angles of the satellites in the second reference frame and carries out an iterative search for the attitude angles of the antenna yielding the minimum of the likelihood function.

Thus, there is no need for an inertial reference.

According to one embodiment, the step for determining the attitude of the antenna in the first reference frame carries out an iterative search for the attitude angles of the antenna yielding the maximum energy after the weighted sums at the output of the correlators of the processing channel respectively associated with the satellites.

Thus, the robustness to scrambling or interference is improved.

In one embodiment, the said maximization uses a least squares solution method.

This implementation is simple.

According to one embodiment, the said maximization uses a method of solution by Kalman filtering.

Such an implementation allows the precision and the robustness to scrambling or interference to be increased.

In one embodiment, discriminators based on direction cosines, representative of the position of the satellites in the second reference frame linked to the antenna, are used.

In one embodiment, a method based on an observational model of the relationship between the direction cosines of the directions of the satellites and the Euler angles of the directions of the satellites is used.

According to another aspect of the invention, a receiver of signals from a satellite navigation system, equipped with an antenna using controlled reception pattern sensors, is provided comprising, for each satellite:
means for calculating the position of the satellite in a first TGL reference frame centred on the receiver using the position of the receiver and the position of the satellite;
means for determining the attitude of the antenna in the first reference frame;
means for determining first elevation and azimuthal angles of the satellite in a second reference frame linked to the antenna, starting from the position of the satellite in the first reference frame and from the attitude of the antenna in the first reference frame;
means for determining second elevation and azimuthal angles of the satellite in the second reference frame, by iterative search for a maximum of a weighted complex sum of the demodulated signals received by the antenna;
means for calculating the value of a likelihood function between the first elevation and azimuthal angles of the satellite and the second elevation and azimuthal angles of the satellite; and
means for detecting a risk of receiving decoy signals when the said value of the likelihood function is lower than a threshold.

The invention will be better understood upon studying embodiments described by way of non-limiting examples and illustrated by the appended drawings in which:

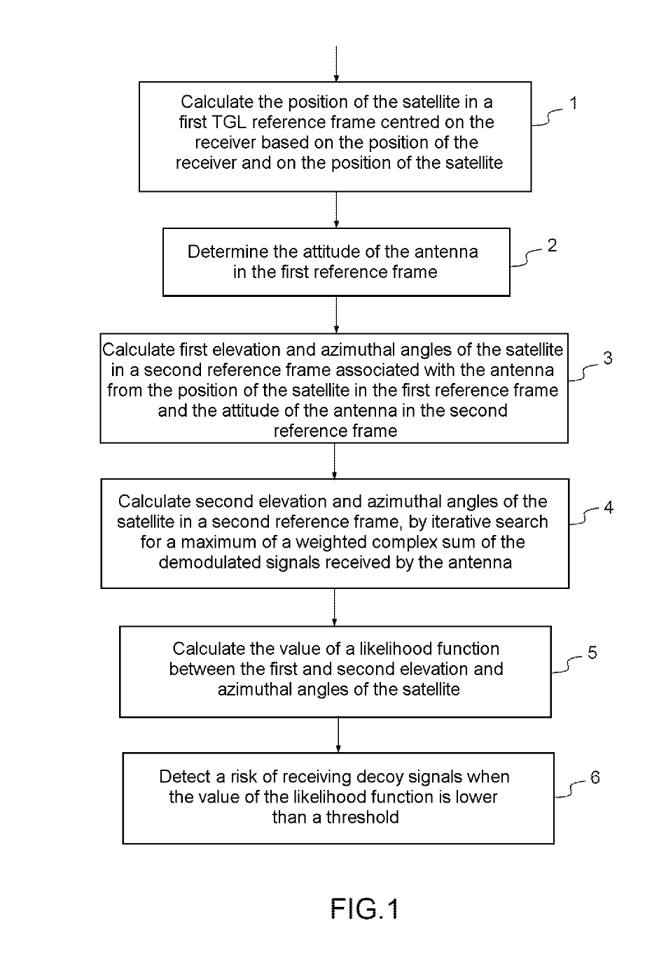

FIG. 1 illustrates schematically a decoy signal detection method, according to one aspect of the invention;

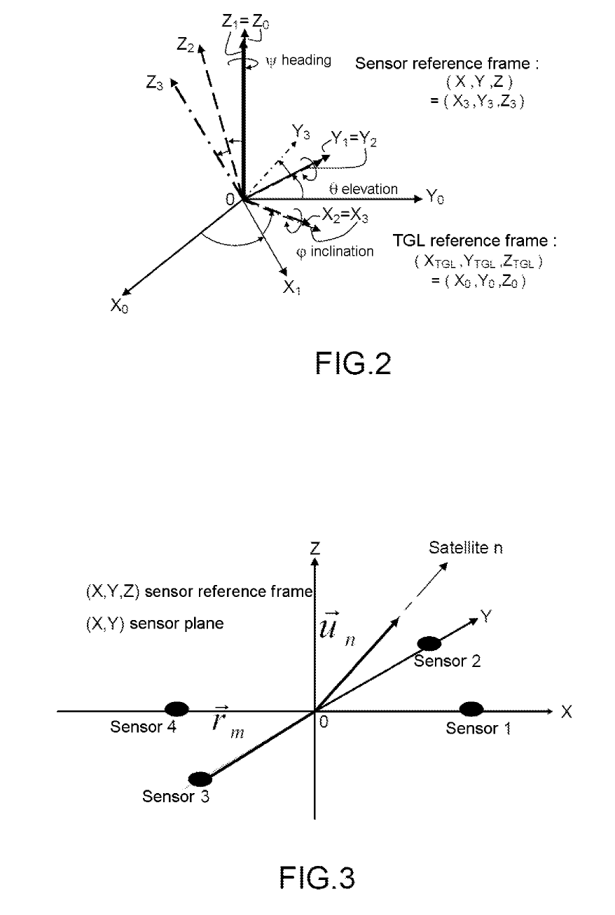

FIG. 2 illustrates the Euler angles;

FIG. 3 illustrates an antenna with four sensors;

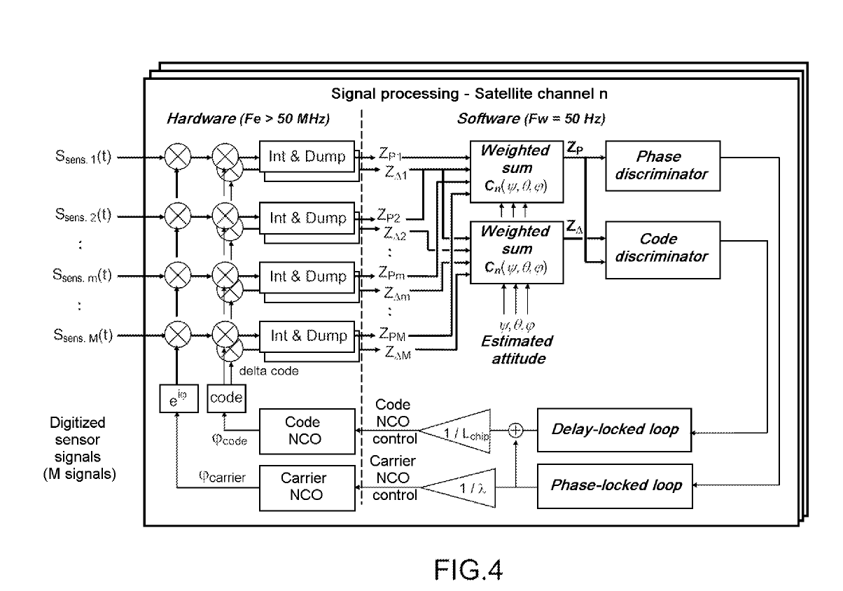

FIG. 4 illustrates a demodulation with tracking loops;

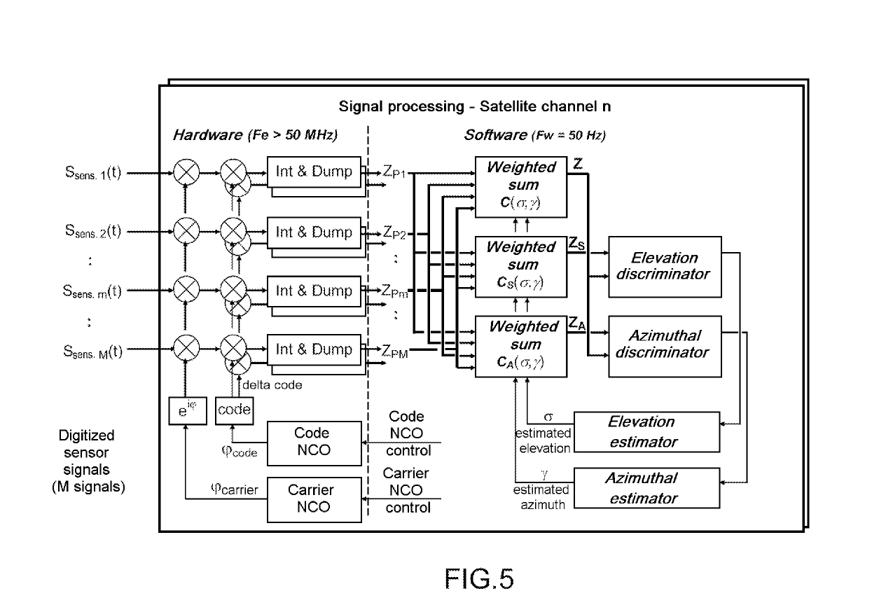

FIG. 5 illustrates the determination of the elevation and azimuthal angles, according to one aspect of the invention;

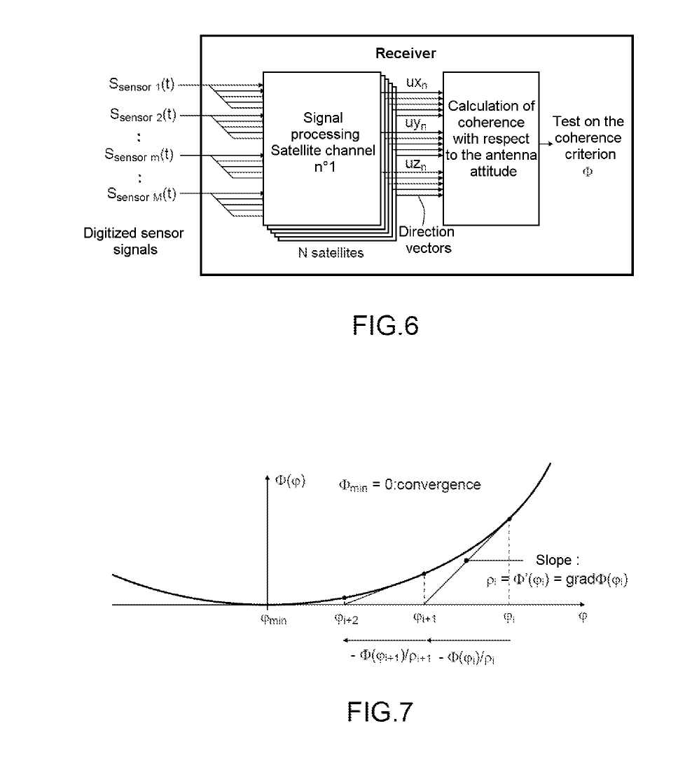

FIG. 6 illustrates coherence checking on the directions of the satellites, according to one aspect of the invention;

FIGS. 7, 8, 9 and 10 illustrate the determination of the attitude of the antenna based on the measured satellite directions;

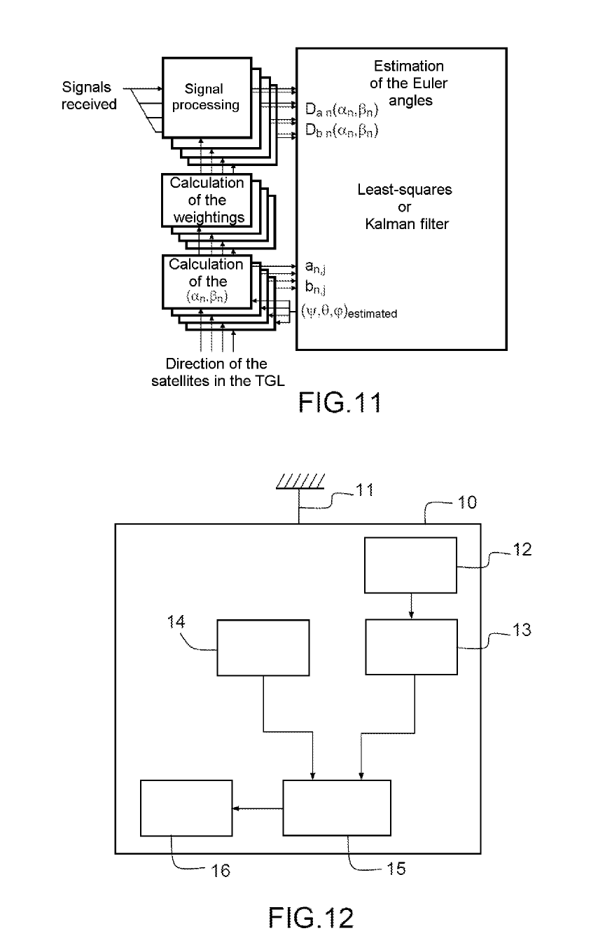

FIG. 11 illustrates a schematic overview of the method according to one aspect of the invention; and

FIG. 12 illustrates a receiver according to one aspect of the invention.

FIG. 1 illustrates a method for detecting signals intended as a decoy for a receiver of signals from a satellite navigation system, according to one aspect of the invention, the receiver being equipped with an antenna using controlled reception pattern sensors.

The method comprises, for each satellite of the satellite navigation system, the following steps:

In a step 1, the position of the satellite is calculated in a first TGL reference frame (Local Geographic Coordinates system North, East, Vertical, centred on the position of the receiver) centred on the receiver from the position of the receiver and from the position of the satellite. The positions of the receiver and of the satellite are known by virtue of almanac data, contained in the navigation messages transmitted by the signals emitted by the satellites.

In a step 2, the attitude, or orientation defined by three angles, of the antenna is determined in the first reference frame. This may be done in several ways, as described later on in the present patent application.

During a step 3, first elevation and azimuthal angles of the satellite are determined in a second reference frame linked to the antenna, based on the position of the satellite in the first reference frame and on the attitude of the antenna in the first reference frame.

In a step 4, second elevation and azimuthal angles of the satellite are determined in the second reference frame, by iterative search for a maximum of a weighted complex sum of the demodulated signals received by the antenna. This step may be carried out in various ways, as described later on in the present application.

In a step 5, the value of a likelihood function between the first elevation and azimuthal angles of the satellite and the second elevation and azimuthal angles of the satellite.

Finally, during a step 6, a risk of receiving decoy signal is detected when the value of the likelihood function is lower than a threshold.

The direction vector between the antenna of the receiver and the satellite with index n of the satellite navigation system, in the first TGL reference frame, is by definition equal to:

$${\vec{u}}_{nTGL} {=}^{def} [ \begin{matrix}{X}_{nTGL} \\ {Y}_{nTGL} \\ {Z}_{nTGL}\end{matrix} ] / ρ$$

The denominator ρ represents the distance separating the antenna of the receiver and the satellite n, independent of the reference frame:

ρ [symbol] \sqrt{Xₙ²+Yₙ²+Zₙ²}=\sqrt{X_{n TGL}²+Y_{n TGL}²+Z_{n TGL}²}

Throughout the present application, the presence of an index def above an equality sign in a mathematical expression means an equality by definition and not by consequence.

The positions of the satellites (X_{n TGL}, Y_{n TGL}, Z_{n TGL}) in the TGL reference frame are calculated using almanac data.

The step 2 for determining the attitude of the antenna conventionally uses an attitude and heading inertial reference, with the acronym AHRS for “Attitude and Heading Reference System”, hybridized with other sensors (anemometry, GPS, Doppler radar, etc.) or by an autonomous inertial reference (IRS—Inertial Reference System).

It is also possible to determine the attitude of the antenna of the receiver by virtue of the signals emitted by the satellites themselves, which arrive with different phase shifts on the sensors of the antenna, depending on the direction of incidence. Several variants are described in the following part of the description.

The step 3 for calculating the directions of the satellites in the second reference frame linked to the antenna, referred to as antenna reference frame or sensor reference frame, may be carried out as follows:

As in FIG. 2, the attitude of the antenna is represented with respect to the first TGL reference frame using the Euler angles: Heading (ψ), Attitude (θ) and Inclination (φ). These angles allow the reference transfer matrix M(ψ, θ, φ) from the first TGL reference frame to the second reference frame linked to the antenna or to the antenna (idem) sensors to be constructed:

$$M ( ψ , θ , ϕ ) {=}^{def} [ \begin{matrix}1 & 0 & 0 \\ 0 & cos ϕ & - sin ϕ \\ 0 & sin ϕ & cos ϕ\end{matrix} ] [ \begin{matrix}cos θ & 0 & - sin θ \\ 0 & 1 & 0 \\ sin θ & 0 & cos θ\end{matrix} ] [ \begin{matrix}cos ψ & sin ψ & 0 \\ - sin ψ & cos ψ & 0 \\ 0 & 0 & 1\end{matrix} ] \\ [ \begin{matrix}{X}_{sensor} \\ {Y}_{sensor} \\ {Z}_{sensor}\end{matrix} ] = M ( ψ , θ , ϕ ) \cdot [ \begin{matrix}{X}_{TGL} \\ {Y}_{TGL} \\ {Z}_{TGL}\end{matrix} ]$$

The direction vector between the antenna of the receiver and the satellite with index n of the satellite navigation system, in the second reference frame linked to the antenna, is by definition equal to:

$${\vec{u}}_{n sensor} {=}^{def} [ \begin{matrix}{X}_{n sensor} \\ {Y}_{n sensor} \\ {Z}_{n sensor}\end{matrix} ] / ρ$$

The denominator ρ represents the distance separating the antenna of the receiver and the satellite n, which is independent of the reference frame:

ρ=\sqrt{Xₙ²+Yₙ²+Zₙ²}=\sqrt{X_{n sensor}²+Y_{n sensor}²+Z_{n sensor}²}

The direction vector of the satellite with index n may thus be expressed as functions of the Euler angles:

$${\vec{u}}_{n sensors} ( ψ , θ , ϕ ) = M ( ψ , θ , ϕ ) \cdot {\vec{u}}_{nTGL}$$

$${\vec{u}}_{n sensors} ( ψ , θ , ϕ ) {=}^{def} [ \begin{matrix}{ux}_{n} ( ψ , θ , ϕ ) \\ {uy}_{n} ( ψ , θ , ϕ ) \\ {uz}_{n} ( ψ , θ , ϕ )\end{matrix} ]$$

In the step 2, the elevation angle γₙ and azimuthal angle αₙ are then calculated in the second reference frame linked to the antenna, based on the attitude angles of the antenna (or of the sensors) in the second reference frame:

$${\vec{u}}_{n sensors} ( ψ , θ , ϕ ) {=}^{def} [ \begin{matrix}cos ( {γ}_{n} ) \cdot cos ( {σ}_{n} ) \\ sin ( {γ}_{n} ) \cdot cos ( {σ}_{n} ) \\ sin ( {σ}_{n} )\end{matrix} ] {=}^{def} [ \begin{matrix}{ux}_{n} ( ψ , θ , ϕ ) \\ {uy}_{n} ( ψ , θ , ϕ ) \\ {uz}_{n} ( ψ , θ , ϕ )\end{matrix} ]$$

The elevation angle in the antenna or sensor reference frame is written:

σₙ(ψ,θ,φ)=sin⁻¹(uzₙ(ψ,θ,φ))

The azimuthal angle in the antenna or sensor reference frame is written:

γₙ(ψ,θ,φ)=tan⁻¹(uxₙ(ψ,θ,φ),uyₙ(ψ,θ,φ))

The direction vector calculated from the variable elevation and azimuthal angles is then written:

$${\vec{u}}_{sensors} ( σ , γ ) {=}^{def} [ \begin{matrix}cos ( γ ) \cdot cos ( σ ) \\ sin ( γ ) \cdot cos ( σ ) \\ sin ( σ )\end{matrix} ] {=}^{def} [ \begin{matrix}ux ( σ , γ ) \\ uy ( σ , γ ) \\ uz ( σ , γ )\end{matrix} ]$$

The direction cosines on the axes X and Y of the antenna reference frame or sensor reference frame may also be taken as direction parameters. The direction cosine on the axis Z is deduced by virtue of the norm being equal to 1.

In order to avoid any ambiguity over the sign of Z, it must be assumed that the satellites are always situated above the plane of the antenna, and hence the satellites below ignored. This is valid in that the satellites low down in the sensor reference frame are not exploitable for the determination of the directions of arrival due to antenna gains being maladapted to a low angle of elevation.

$${\vec{u}}_{sensors} ( α , β ) {=}^{def} [ \begin{matrix}α \\ β \\ \sqrt{1 - {α}^{2} - {β}^{2}}\end{matrix} ] {=}^{def} [ \begin{matrix}ux ( α , β ) \\ uy ( α , β ) \\ uz ( α , β )\end{matrix} ]$$

The elevation angle in the antenna or sensor reference frame is written:

σ(α,β)=tan⁻¹(\sqrt{α²+β²},\sqrt{1−α²+β²})

The azimuthal angle in the sensor reference frame is written:

γ(α,β)=tan⁻¹(α,β)

By noting the vector position of the sensor m as

$${\vec{r}}_{m sensors} {=}^{def} [ \begin{matrix}{X}_{m sensor} \\ {Y}_{m sensor} \\ {Z}_{m sensor}\end{matrix} ]$$

in the sensor reference frame, known for example by virtue of the measurements of the phase centre at the factory, in one example with four antenna sensors, the following is obtained:

$${\vec{r}}_{1 sensors} = [ \begin{matrix}r \\ 0 \\ 0\end{matrix} ] {\vec{r}}_{2 sensors} = [ \begin{matrix}0 \\ r \\ 0\end{matrix} ] {\vec{r}}_{3 sensors} = [ \begin{matrix}- r \\ 0 \\ 0\end{matrix} ] {\vec{r}}_{4 sensors} = [ \begin{matrix}0 \\ - r \\ 0\end{matrix} ]$$

as illustrated in FIG. 3.

The theoretical phase differences between the signals received by the antenna sensors are calculated from the variable elevation and azimuthal angles.

The difference in optical path between the centre of the second antenna reference frame and the sensor with index m for the signal received from the satellite n is expressed as follows:

ε_{m,n}(ψ,θ,φ) [symbol] \vec{u}_{n sensor}(ψ,θ,φ)·\vec{r}_{m sensors}(in m)

The corresponding phase-shift is expressed as follows:

δ_{m,n}(ψ,θ,φ) [symbol] \vec{u}_{n sensor}(ψ,θ,φ)·\vec{r}_{m sensors}·(2π/λ)(in rad)

λ representing the wavelength of the carrier.

The phase-shift for variable elevation and azimuthal angles may then be calculated σ, γ. The difference in optical path is then calculated:

εₘ(σ,γ) [symbol] \vec{u}ₛₑₙₛₒᵣₛ(σ,γ)·\vec{r}_{m sensors}(in m)

and the corresponding phase-shift:

δₘ(σ,γ) [symbol] \vec{u}ₛₑₙₛₒᵣₛ(σ,γ)·\vec{r}_{m sensors}·(2π/λ)(in rad)

The index n corresponding to the position of the satellite is no longer used as soon as the elevation and azimuthal angles in the second sensor reference frame are known.

The phase difference for variable direction cosines is calculated. First of all, the difference in optical path is calculated:

εₘ(α,β) [symbol] \vec{u}ₛₑₙₛₒᵣₛ(α,β)·\vec{r}_{m sensors}(in m)

and the corresponding phase difference:

δₘ(α,β) [symbol] \vec{u}ₛₑₙₛₒᵣₛ(α,β)·\vec{r}_{m sensors}·(2π/λ)(in rad)

The use of the index n is obviated since the position of the satellite is no longer involved as soon as the variable elevation and azimuthal angles are used.

The demodulation of the signals, digitized at the sampling frequency Fe, is carried out by hardware means in a “wired” digital component, ASIC or FPGA. It requires a very high processing frequency which is difficult to achieve with software means.

The demodulation is specific to each satellite signal, characterized by its spreading code and its Doppler shift.

In the present application, all the signals received by the sensors are demodulated in parallel within each hardware satellite channel.

The demodulation operates by multiplication of the received signal by a complex local carrier and by a real local code then integration of the product over consecutive intervals of time (this is the correlation). There are in fact two correlation channels per received signal: a instantaneous channel with a local code in phase with the received code and a delta channel with a “delta” code or difference between advanced code and retarded code, according to the prior art.

FIG. 4 shows one example of a demodulation with the tracking loops.

The weighted sums of the demodulated signals from the various sensors are carried out using a low-frequency software application (typically Fw=50 Hz).

The role of the complex weighting coefficients is to bring the signals from the sensors into phase at the output of the correlation channels with the aim of obtaining the maximum amplitude after the sum.

The directions of the satellites calculated from the elevation and azimuthal angles are used to determine the weighting coefficients.

The results at the output of the correlators prior to weighting are written:

$${Z}_{P sensors} {=}^{def} {[ \begin{matrix}{Z}_{P 1} \\ {Z}_{P 2} \\ {Z}_{P 3} \\ ⋮ \\ {Z}_{PM}\end{matrix} ]}_{M \times 1}$$

$${Z}_{Δ sensors} {=}^{def} {[ \begin{matrix}{Z}_{Δ 1} \\ {Z}_{Δ 2} \\ {Z}_{Δ 3} \\ ⋮ \\ {Z}_{Δ M}\end{matrix} ]}_{M \times 1}$$

The weighting on the instantaneous channel is then written:

Z_{P} [symbol] Cₙ^{T}(ψ,θ,φ)·Z_{P sensors}(scalar product)

Z_{P} [symbol] C_{1,n}(ψ,θ,φ)·Z_{P1}+C_{2,n}(ψ,θ,φ)·Z_{P2}+ . . . +C_{M,n}(ψ,θ,φ)·Z_{PM}

The weighting on the Delta channel (code discriminator) is then written:

Z_{Δ} [symbol] Cₙ^{T}(ψ,θ,φ)·Z_{Δsensors}(scalar product)

Z_{Δ} [symbol] C_{1,n}(ψ,θ,φ)·Z_{Δ1}+C_{2,n}(ψ,θ,φ)·Z_{Δ2}+ . . . +C_{M,n}(ψ,θ,φ)·Z_{ΔM}

The complex weighting coefficients are then written:

$${C}_{n} ( ψ , θ , ϕ ) {=}^{def} {[ \begin{matrix}{C}_{1 , n} ( ψ , θ , ϕ ) \\ {C}_{2 , n} ( ψ , θ , ϕ ) \\ {C}_{3 , n} ( ψ , θ , ϕ ) \\ ⋮ \\ {C}_{M , n} ( ψ , θ , ϕ )\end{matrix} ]}_{M \times 1}$$

$${C}_{m , n} ( ψ , θ , ϕ ) {=}^{def} {A}_{sensor m} ( {σ}_{n} , {γ}_{n} ) \cdot exp i ( \begin{matrix}{δ}_{m , n} ( ψ , θ , ϕ ) + \\ {B}_{sensor m} ( {σ}_{n} , {γ}_{n} )\end{matrix} )$$

A_{sensor m}(σₙ, γₙ) representing the relative amplitude due to the sensor m in the direction of the satellite n calculated from the prior knowledge of the antenna radiation diagrams, including the attenuations due to the analogue RF channels.

B_{sensor m}(σₙ, γₙ) representing the phase-shift due to the sensor m in the direction of the satellite n calculated based on the prior knowledge of the antenna radiation diagrams, including the phase-shifts due to the analogue RF channels.

It is possible to identify the bias of the sensors at the factory, but this increases the cost of production of the equipment (calibration means and time spent) and does not allow any compensation for the aging of the sensor.

It is also possible to identify the phase-shifts of the sensors by virtue of the signals from the satellites using a specific processing operation (et document FR 2972809).

The tracking loops (code and carrier) are constituted by software means because they operate at low frequency (typically, of the order of Fw=50 Hz), they use more complex mathematical functions, and they use various modes (search, transition, tracking, degraded tracking, etc.)

A phase discriminator is used:

Dφ(k)=argument(Z_{P})

Dφ(k)=arc tangent(I_{P},Q_{P})Z_{P}=I_{P}+j·Q_{P}

I representing the real part, and Q representing the imaginary part

Dφ(k)=θZ_{P}=ρe^{iθ}

ρ representing the modulus, and θ representing the argument K representing the index of the resetting period (typically periods of 20 ms for Fw=50 Hz)

A code discriminator is also used:

D_{code}(k)=real part(Z_{Δ}·Z_{P*})Z_{P*}=conjugate(Z_{P*})=I_{P}−j·Q_{P}

D_{code}(k)=I_{P}·I_{Δ}+j·(I_{P}·I_{Δ})

A phase-locked loop (or PLL) is used:

A_{carrier}(k)=A_{carrier}(k−1)+T·K_{carrier 3}·Dφ(k)·λ_{carrier}/(2π)(in m/s²)

V_{carrier}(k)=V_{carrier}(k−1)+TA_{carrier}(k)+T·K_{carrier 2}·Dφ(k)·λ_{carrier}/(2π)(in m/s)

C_{carrier}(k)=V_{carrier}(k)+K_{carrier 1}·Dφ(k)·λ_{carrier}/(2π)(in m/s)

A delay-locked loop (DLL) is used:

V_{code}(k)=V_{code}(k−1)+TA_{code}(k)+T·K_{code 2}·D_{code}(k)·L_{chip}(in m/s)

C_{code}(k)=V_{code}(k)+K_{code 1}·D_{code}(k)·L_{chip}(in m/s)

With regard to the numerically controlled oscillators (or NCO):

C_{NCO carrier}(k)=C_{carrier}(k)/λ_{carrier}(in Hz)

C_{NCO code}(k)=(C_{carrier}(k)+C_{code}(k))/L_{chip}(in Hz)

In the step 4, the second elevation and azimuthal angles are then determined as follows. This involves the determination of the directions of arrival of the signals being tracked.

From satellite to satellite, the second elevation and azimuthal angles are sought (angles of arrival in the second antenna or sensor reference frame) which maximize the power after the weighted sum.

This processing operation is carried out by software means, at the same time as the tracking loops, as illustrated in FIG. 5.

The complex weighting coefficients to be optimized are written according to the following criterion:

$$C ( σ , γ ) {=}^{def} {[ \begin{matrix}{C}_{1} ( σ , γ ) \\ {C}_{2} ( σ , γ ) \\ {C}_{3} ( σ , γ ) \\ ⋮ \\ {C}_{M} ( σ , γ )\end{matrix} ]}_{M \times 1}$$

$${C}_{m} ( σ , γ ) {=}^{def} exp i ( {δ}_{m} ( σ , γ ) + {B}_{sensor m} ( σ , γ ) )$$

The values of the elevation angle α and azimuthal angle γ are sought which maximize the criterion C(σ,γ):

Ψ(σ,γ) [symbol] ∥Z(σ,γ)∥2

Ψ(σ,γ) [symbol] ∥CT(σ,γ)·Z_{P sensors}∥2

Ψ(σ,γ) [symbol] [CT(σ,γ)·Z_{P sensor}]·[CT(σ,γ)·ZP sensors]*

This maximization may be achieved in several different ways.

This maximisation can be carried out by a search for a maximum within all of the possible values of σ and α respectively included within [0,π] and [0,2π], with a sampling step that is sufficiently small for the required precision.

It is also possible to carry out a search for a maximum by the iterative gradient method, approaching the maximum with each iteration.

$$[ \begin{matrix}{σ}_{i + 1} \\ {γ}_{i + 1}\end{matrix} ] = [ \begin{matrix}{σ}_{i} \\ {γ}_{i}\end{matrix} ] + {μ}_{i} \cdot \vec{G} rad Ψ ( {σ}_{i} , {γ}_{i} )$$

$$\vec{G} rad Ψ ( σ , γ ) {=}^{def} [ \begin{matrix}\frac{\partial Ψ}{\partial σ} ( σ , γ ) \\ \frac{\partial Ψ}{\partial γ} ( σ , γ )\end{matrix} ]$$

i represents the index of the iteration

$$\vec{G} rad Ψ ( σ , γ ) = [ \begin{matrix}Re ( [ \frac{\partial {C}^{T}}{\partial σ} ( σ , γ ) \cdot {Z}_{P sensors} ] \cdot {[ {C}^{T} ( σ , γ ) \cdot {Z}_{P sensors} ]}^{*} ) \\ Re ( [ \frac{\partial {C}^{T}}{\partial γ} ( σ , γ ) \cdot {Z}_{P sensors} ] \cdot [ {( {C}^{T} ( σ , γ ) \cdot {Z}_{P sensors} ]}^{*} )\end{matrix} ]$$

$$\vec{G} rad Ψ ( σ , γ ) = [ \begin{matrix}Re ( {Z}_{S } ( σ , γ ) \cdot {Z ( σ , γ )}^{*} ) \\ Re ( {Z}_{A} ( σ , γ ) \cdot {Z ( σ , γ )}^{*} )\end{matrix} ]$$

With:

$$Z ( σ , γ ) {=}^{def} {C}^{T} ( σ , γ ) \cdot {Z}_{P sensors}$$

$${Z}_{S} ( σ , γ ) {=}^{def} \frac{\partial {C}^{T}}{\partial σ} ( σ , γ ) \cdot {Z}_{P sensors}$$

$${Z}_{A} ( σ , γ ) {=}^{def} \frac{\partial {C}^{T}}{\partial γ} ( σ , γ ) \cdot {Z}_{P sensors}$$

Notation: Re(z) represents the real part of z

Discriminators are constructed for estimating the error in elevation and in azimuth and in order to converge faster towards the real values (σ₀,γ₀) yielding the maximum power after weighting.

Elevation and azimuthal discriminators are used:

D_{S}(σ,γ) [symbol] Re[Z_{S}(σ,γ)·Z(σ,γ)*]/∥Z∥²/ρ_{S}=Re(Z_{S}/Z*)/ρ_{S}

D_{A}(σ,γ) [symbol] Re[Z_{A}(σ,γ)·Z(σ,γ)*]/∥Z∥²/ρ_{A}=Re(Z_{A}/Z*)/ρ_{A}

The “instantaneous” weighted sum is used:

Z(σ,γ) [symbol] C^{T}(σ,γ)·Z_{P sensors}

and the weighted sums with complex “delta” weightings:

$${Z}_{S} ( σ , γ ) {=}^{def} {C}_{S}^{T} ( σ , γ ) \cdot {Z}_{P sensors} {C}_{S}^{T} ( σ , γ ) {=}^{def} \frac{\partial {C}^{T}}{\partial σ} ( σ , γ )$$

$${Z}_{A} ( σ , γ ) {=}^{def} {C}_{A}^{T} ( σ , γ ) \cdot {Z}_{P snsors} {C}_{A}^{T} ( σ , γ ) {=}^{def} \frac{\partial {C}^{T}}{\partial γ} ( σ , γ )$$

In order to calculate the sensitivity of the discriminators, the following is posed:

$$Π ( σ , γ ) {=}^{def} {C}^{T} ( σ , γ ) \cdot C ( {σ}_{0} , {γ}_{0} )$$

$${Δ}_{S} ( σ , γ ) {=}^{def} \frac{\partial {C}^{T}}{\partial σ} ( σ , γ ) \cdot C ( {σ}_{0} , {γ}_{0} ) = \frac{\partial }{\partial σ} ( Π ) ( α , β )$$

$${Δ}_{A} ( σ , γ ) {=}^{def} \frac{\partial {C}^{T}}{\partial σ} ( σ , γ ) \cdot C ( {σ}_{0} , {γ}_{0} ) = \frac{\partial }{\partial γ} ( Π ) ( α , β )$$

The signal received is expressed:

Z_{P sensors}=C(σₜᵣᵤₑ,γₜᵣᵤₑ)·T·\sqrt{P}+noise

P representing the power of the received signal, and

T representing the time for coherent integration.

The vector C(σₜᵣᵤₑ,γₜᵣᵤₑ) is representative of the complex amplitudes received on each sensor. The angles (σₜᵣᵤₑ,γₜᵣᵤₑ) correspond to the true direction hence to the maximum of Ψ(σ,γ). This leads to:

$$Z ( σ , γ ) = {C}^{T} ( σ , γ ) \cdot C ( {σ}_{true} , {γ}_{true} ) \cdot T \cdot \sqrt{P}$$

$${Z}_{S} ( σ , γ ) = \frac{\partial {C}^{T}}{\partial σ} ( σ , γ ) \cdot C ( {σ}_{true} , {γ}_{true} ) \cdot T \cdot \sqrt{P}$$

$${Z}_{A} ( σ , γ ) = \frac{\partial {C}^{T}}{\partial γ} ( σ , γ ) \cdot C ( {σ}_{true} , {γ}_{true} ) \cdot T \cdot \sqrt{P}$$

Under the assumption that (σₜᵣᵤₑ, γₜᵣᵤₑ) is known, posing (σ₀, γ₀)=(σₜᵣᵤₑ, γₜᵣᵤₑ) yields:

Z(σ,γ)=Π(σ,γ)·T·\sqrt{P}

Z_{S}(σ,γ)=Δ_{S}(σ,γ)·T·\sqrt{P}

Z_{A}(σ,γ)=Δ_{A}(σ,γ)·T·\sqrt{P}
which leads to:

D_{S}(σ,γ)=Re[Δ_{S}·Π]/∥Π∥²/ρ_{S}

D_{A}(σ,γ)=Re[Δ_{A}·Π]/∥Π∥²/ρₐ

In order to normalize the sensitivity of the discriminators to 1, the following is posed:

$${ρ}_{S} {=}^{def} \frac{\partial }{\partial σ} ( Re [ {Δ}_{S} \cdot Π ] / {‖ Π ‖}^{2} ) ( {σ}_{0} , {γ}_{0} )$$

$${ρ}_{A} {=}^{def} \frac{\partial }{\partial γ} ( Re [ {Δ}_{A} \cdot Π ] / {‖ Π ‖}^{2} ) ( {σ}_{0} , {γ}_{0} )$$

Thus:

D_{S}(σ,γ)≅(σ−σₜᵣᵤₑ)+noise

D_{A}(σ,γ)≅(γ−γₜᵣᵤₑ)+noise

The discriminators indeed allow the elevation and azimuthal errors to be estimated.

In order to calculate these “delta” weightings, the finite difference method may be used:

$${C}_{S} ( σ , γ ) = \frac{\partial C}{\partial σ} ( σ , γ ) ≅ \frac{C ( σ + d σ , γ ) - C ( σ , γ )}{d σ}$$

$${C}_{A} ( σ , γ ) = \frac{\partial C}{\partial γ} ( σ , γ ) ≅ \frac{C ( σ , α + d γ ) - C ( σ , γ )}{d γ}$$

For small values of dσ and dα, the result is very close to the derivative, and this method avoids having to recode a derivative calculation in the receiver.

As the true values (σᵣᵤₑ,γₜᵣᵤₑ) of (σ,γ) are not known, the values estimated in the preceding step (σᵢ,γᵢ) are taken instead.

The gradient method converges towards a local maximum which is the absolute maximum if the initial values σ₀ and γ₀ are close to it. For this purpose, a global search is initially carried out with a large sampling step, for example a step of around 30°.

The speed of convergence depends on the choice of the resetting gain μᵢ. A constant gain equal to 1 may for example be taken.

The convergence criterion can be the norm of the increment μᵢ·\vec{G}radΦ(σᵢ,γᵢ).

Once the algorithm, applied to the same vector Z_{P sensor}(k) with the period k has converged, the values of σ and γ thus obtained may be used to reset the search to the following step k+1. If the antenna is on a carrier with a normal attitude dynamic behaviour, the new elevation and azimuthal values must not be too far from the preceding ones, which then permits an iteration by period k:

$$[ \begin{matrix}{σ}_{k + 1} \\ {γ}_{k + 1} \end{matrix} ] = [ \begin{matrix}{σ}_{k} \\ {γ}_{k}\end{matrix} ] + [ \begin{matrix}{μ}_{Sk} \cdot {D}_{S} ( {σ}_{k} , {γ}_{k} ) \\ {μ}_{Ak} {D}_{A} ( {σ}_{k} , {γ}_{k} )\end{matrix} ]$$

As values of resetting gain, μ_{S}=μ_{A}=1/τ (τ: time constant) may for example be taken.

A Kalman filter may also be used to optimize the resetting gains μ_{S} and μ_{A}.

It is possible to carry out the same search using the direction cosines a and β as parameters.

### The Coherence on the Directions of the Satellites is Verified.

Once the receiver has determined the directions of arrival of the signals from the satellite in the second antenna reference frame, represented by the elevation and azimuthal angles for each satellite, it can verify if these directions are coherent with the attitude angles of the antenna determined elsewhere.

For these purposes, the sum of the squares of the differences between the elevation angle σₙ and azimuthal angle γₙ may be used as criterion, which is determined on the demodulated signal at the output of the correlators and those calculated from the attitude angles and from the direction of the satellites. Nevertheless, because of discontinuities in the angles, it is preferable to carry out the comparison directly on the direction vectors:

Φ [symbol] Σ_{n=1, . . . ,N}∥σₙ(ψ,θ,φ)−σ_{k,n}∥²+∥γₙ(ψ,θ,φ)−γ_{k,n}∥

This is illustrated in FIG. 6.

If the criterion exceeds a predetermined threshold, then a decoy attempt is detected and the receiver informs the user of the risk being run, by means of an alarm, for example visual or audio.

The receiver may also decide to restart an acquisition with the hope of recovering the genuine signal, until coherent measurements are obtained.

Subsequently, in the steps 4 and 5, a coherence check is carried out, as illustrated in FIG. 7. Once the receiver has determined, in the step 4, the directions of arrival of the satellite signals in the sensor reference frame, represented by the elevation and azimuthal angles for each satellite, it can verify whether these directions are coherent with the attitude angles of the antenna furthermore determined in the step 3.

For this purpose, a likelihood function can be used between the first and second elevation and azimuthal angles, in the step 5.

For example, as a criterion, the sum may be taken of the square of the differences between the elevation angle σₙ and of azimuthal angle αₙ determined on the demodulated signal at the output of the correlators and those calculated from the attitude angles and from the direction of the satellites. Nevertheless, because of discontinuities in the angles, the comparison may be carried out directly on the direction vectors:

Φ [symbol] Σ_{n=1, . . . ,N}∥\vec{u}_{n sensors}(ψ,θ,φ)−\vec{u}ₛₑₙₛₒᵣₛ(σ_{k,n},γ_{k,n})∥²

If the criterion exceeds a predetermined threshold, then a decoy attempt is detected and the receiver informs the user of the risk being run, by means of an alarm, for example visual or audio.

The receiver may also decide to restart an acquisition with the hope of recovering the genuine signal, until coherent measurements are obtained.

With regard to the step 2 for determining the attitude of the antenna in the first TGL reference frame, the latter can be supplied by an inertial navigation system or attitude reference.

When the receiver does not dispose of an attitude reference, it is possible to determine the attitude angles based on the satellites directions in the sensor reference frame determined from the received signals, in the step 4. In this case, in a decoy attempt situation, the coherence criterion will be reduced with respect to the case where an external reference is available, but owing to the multiplicity of the satellites, the incoherence will still be detected.

In the step 4, the attitude of the antenna is determined as follows.

The relationship between the Euler angles (ψ,θ,φ) and the directions of arrival is not linear. It is not possible to use a direct solution algorithm, for example the least squares method.

It is possible to carry out a search within the domain of the Euler angles: for each hypothesis (ψ,θ,φ) considered, the assumed directions of arrival of the signals are calculated in the second reference frame or sensor reference frame, then the criterion this coherence. The values of the angles yielding the minimum criterion are chosen.

Φ(ψ,θ,φ) [symbol] Σ_{n=1, . . . ,N}∥\vec{u}_{n sensors}(ψ,θ,φ)−\vec{u}ₛₑₙₛₒᵣₛ(σ_{k,n},γ_{k,n})∥²

Nevertheless, a complete search of the domain within which the Euler angles take their values would be very long and costly in processing power:

The heading ψ takes its values within [0,2π] or [0°,360°]

The attitude θ takes its values within [−π,π] or [−180°,180°]

The inclination φ takes its values within [−π,π] or [−180°,180°]

If sampling is done in steps of 10°, that makes 36×36×36=46656 hypotheses to process.

It is preferred to carry out an iterative search by moving towards the minimum at each iteration.

The Newton method may be used in a space with several dimensions:

$$[ \begin{matrix}{ψ}_{i + 1} \\ {θ}_{i + 1} \\ {ϕ}_{i + 1}\end{matrix} ] = [ \begin{matrix}{ψ}_{i} \\ {θ}_{i} \\ {ϕ}_{i}\end{matrix} ] - Φ ( {ψ}_{i} , {θ}_{i} , {ϕ}_{i} ) \cdot \frac{\vec{G} rad Φ ( {ψ}_{i} , \begin{matrix}{θ}_{i} & {ϕ}_{i}\end{matrix} )}{{‖ \vec{G} rad Φ ( {ψ}_{i} , {θ}_{i} , {ϕ}_{i} ) ‖}^{2}}$$

with:

$$\vec{G} rad Φ ( ψ , θ , ϕ ) {=}^{def} [ \begin{matrix}\frac{\partial Φ}{\partial ψ} ( ψ , θ , ϕ ) \\ \frac{\partial Φ}{\partial θ} ( ψ , θ , ϕ ) \\ \frac{\partial Φ}{\partial ϕ} ( ψ , θ , ϕ )\end{matrix} ]$$

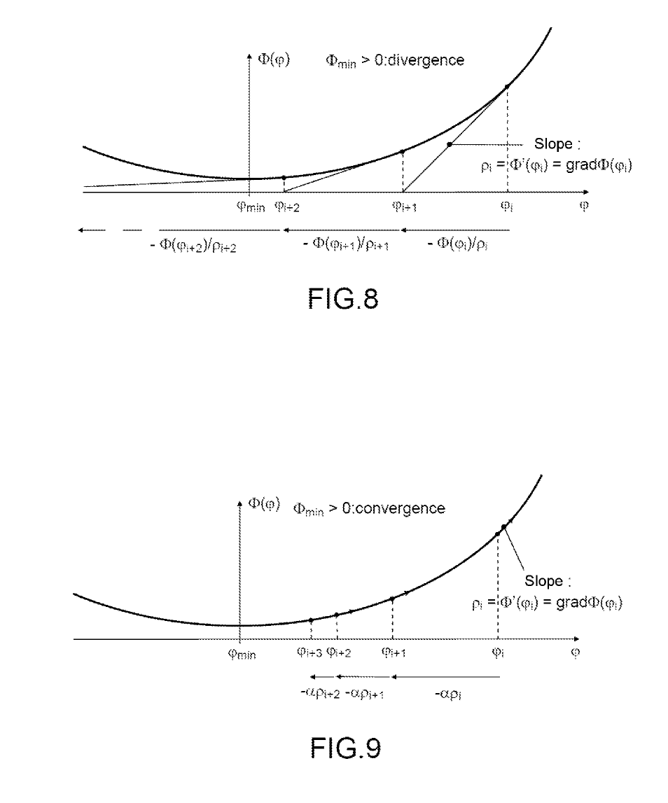

When the minimum of the likelihood criterion is zero, the method converges very quickly towards this minimum, as illustrated in FIG. 8. This is the ideal case in which there exists an exact solution (zero residue), in other words the case in which the d_{m,n measured} are without measurement noise and where the antennas biases β_{0 sensor m} are perfectly tabulated.

In reality, it is not very probable that the sum of the squares of the residues are zero. It should therefore be expected that it will be more difficult for the method to converge, as illustrated in FIG. 9.

In order to avoid the divergence, a more slowly converging, but more robust, method can advantageously be used:

$$[ \begin{matrix}{ψ}_{i + 1} \\ {θ}_{i + 1} \\ {ϕ}_{i + 1}\end{matrix} ] = [ \begin{matrix}{ψ}_{i} \\ {θ}_{i} \\ {ϕ}_{i}\end{matrix} ] - α \cdot \vec{G} rad Φ ( {ψ}_{i} , {θ}_{i} , {ϕ}_{i} )$$

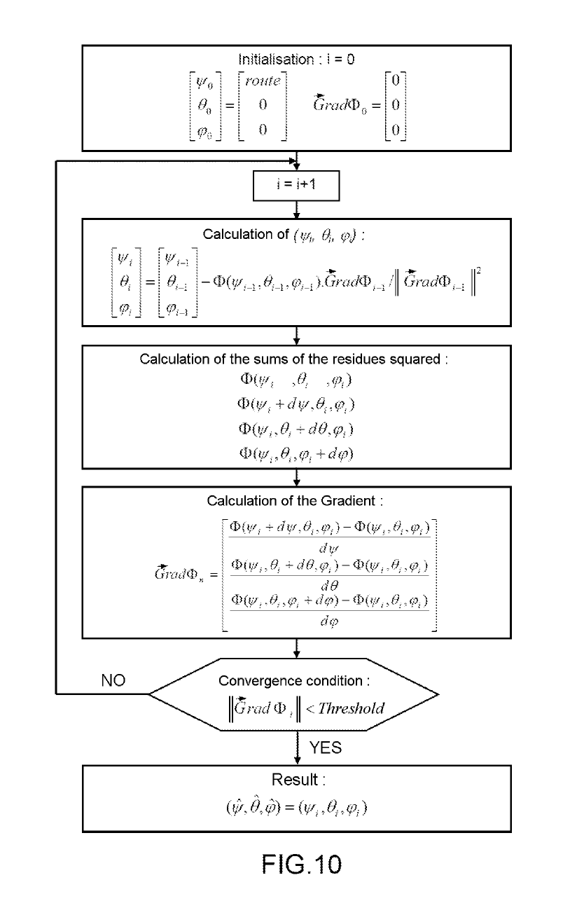

as illustrated in FIG. 10.

In order to calculate the gradient, the finite difference method can be used, as illustrated in FIG. 11, by using:

$$\vec{G} rad Φ ( ψ , θ , ϕ ) {=}^{def} {lim}_{d -> 0} [ \begin{matrix}\frac{Φ ( ψ + d ψ , θ , ϕ ) - Φ ( ψ , θ , ϕ )}{d ψ} \\ \frac{Φ ( ψ , θ + d θ , ϕ ) - Φ ( ψ , θ , ϕ )}{d θ} \\ \frac{Φ ( ψ , θ , ϕ + d ϕ ) - Ψ ( ψ , θ , ϕ )}{d ϕ}\end{matrix} ]$$

$$\vec{G} rad Φ ( ψ , θ , ϕ ) ≅ [ \begin{matrix}\frac{Φ ( ψ + d ψ , θ , ϕ ) - Φ ( ψ , θ , ϕ )}{d ψ} \\ \frac{Φ ( ψ , θ + d θ , ϕ ) - Φ ( ψ , θ , ϕ )}{d θ} \\ \frac{Φ ( ψ , θ , ϕ + d ϕ ) - Φ ( ψ , θ , ϕ )}{d ϕ}\end{matrix} ]$$

for small values of dye, de and do

As a variant, the step 2 for determining the attitude of the antenna in the first reference frame or antenna or sensor reference frame.

Instead of determining the attitude angles of the antenna based on the estimated directions of arrival of the signals in the sensor reference frame in the step 4, which may be false in the case of decoy attempt, it may be preferred to search for the attitude angles yielding the maximum energy after the weighted sums at the output of the correlators. It is therefore then sought to maximize the sum of the energies over all the demodulated satellite signals:

Ψ(φ,θ,ψ) [symbol] Σn=1, . . . ,N∥Z_{P n}(φ,θ,ψ)∥2

Ψ(φ,θ,ψ) [symbol] Σn=1, . . . ,N∥Cₙ^{T}(φ,θ,ψ)·Z_{P sensors n}∥2

Ψ(φ,θ,ψ) [symbol] Σn=1, . . . ,N[Cₙ^{T}(φ,θ,ψ)·Z_{P sensors n}]·[C^{T}(σ,γ)·Z_{P sensors n}]*

The gradient method can be used:

$$\begin{matrix}\vec{G} rad Ψ ( ψ , θ , ϕ ) = {\sum }_{n = 1 , … , N} [ \begin{matrix}Re ( \begin{matrix}[ \frac{\partial {C}_{n}^{T}}{\partial ψ} ( ψ , θ , ϕ ) \cdot {Z}_{P sensors n} ] \cdot \\ {[ {C}_{n}^{T} ( ψ , θ , ϕ ) \cdot {Z}_{P sensors n} ]}^{*}\end{matrix} ) \\ Re ( \begin{matrix}[ \frac{\partial {C}_{n}^{T}}{\partial θ} ( ψ , θ , ϕ ) \cdot {Z}_{P sensors n} ] \cdot \\ {[ {C}_{n}^{T} ( ψ , θ , ϕ ) \cdot {Z}_{P sensors n} ]}^{*}\end{matrix} ) \\ Re ( \begin{matrix}[ \frac{\partial {C}_{n}^{T}}{\partial ϕ} ( ψ , θ , ϕ ) \cdot {Z}_{P sensors n} ] \cdot \\ {[ {C}_{n}^{T} ( ψ , θ , ϕ ) \cdot {Z}_{P sensors n} ]}^{*}\end{matrix} )\end{matrix} ] & \\ {C}_{n} ( ψ , θ , ϕ ) = {[ \begin{matrix}{C}_{1 , n} ( ψ , θ , ϕ ) \\ {C}_{2 , n} ( ψ , θ , ϕ ) \\ {C}_{3 , n} ( ψ , θ , ϕ ) \\ ⋮ \\ {C}_{M , n} ( ψ , θ , ϕ )\end{matrix} ]}_{M \times 1} \\ {C}_{m , n} ( ψ , θ , ϕ ) = exp i ( {δ}_{m , n} ( ψ , θ , ϕ ) + {\hat{β}}_{sensor m} ( \begin{matrix}{σ}_{n} ( ψ , θ , ϕ ) , \\ {γ}_{n} ( ψ , θ , ϕ )\end{matrix} ) ) \\ {δ}_{m , n} ( ψ , θ , ϕ ) = {\vec{u}}_{n sensors} ( ψ , θ , ϕ ) \cdot {\vec{r}}_{m sensors} \cdot ( 2 π / λ ) ( in rad ) \\ {\vec{u}}_{n sensors} ( ψ , θ , ϕ ) = [ \begin{matrix}cos ( {γ}_{n} ) \cdot cos ( {σ}_{n} ) \\ sin ( {γ}_{n} ) \cdot cos ( {σ}_{n} ) \\ sin ( {σ}_{n} )\end{matrix} ] = [ \begin{matrix}{ux}_{n} ( ψ , θ , ϕ ) \\ {uy}_{n} ( ψ , θ , ϕ ) \\ {uz}_{n} ( ψ , θ , ϕ )\end{matrix} ] & \end{matrix}$$

The elevation angle in the sensor reference frame is then written:

σₙ(ψ,θ,φ)=sin⁻¹(uzₙ(ψ,θ,φ))

The azimuthal angle in the sensor reference frame is then written:

γₙ(ψ,θ,φ)=tan⁻¹(uxₙ(ψ,θ,φ),uyₙ(ψ,θ,φ))

Three “delta” weightings per satellite must then be applied, which is costly in number of calculations.

Discriminators may then be used.

The direction cosines (α,β) in the sensor reference frames or second reference frame are taken as parameters for directions of the satellites. Discriminators are calculated at the output of the correlators in order to measure the errors made on the directions of the satellites.

D_{a n}(α,β) [symbol] Re[Z_{a n}(α,β)·Zₙ(α,β)*]/∥Z∥²/ρₐ=Re(Zₐ/Z*)/ρₐ

D_{b n}(α,β) [symbol] Re[Z_{a n}(α,β)·Zₙ(α,β)*]/∥Z∥²/ρ_{b}=Re(Z_{b}/Z*)/ρ_{b}

The calculations are performed with the same formulae as those used with the elevation and azimuthal angles (σ,γ)

Instantaneous weighted sum:

Z_{P n}(α,β) [symbol] C^{T}(α,β)·Z_{P n sensors}

Weighted sums with the complex “delta” weightings:

$${Z}_{an} ( α , β ) {=}^{def} {C}_{a}^{T} ( α , β ) \cdot {Z}_{P n sensors}$$

$${C}_{a} ( α , β ) {=}^{def} \frac{\partial {C}^{T}}{\partial α} ( α , β )$$

$${Z}_{bn} ( α , β ) {=}^{def} {C}_{b}^{T} ( α , β ) \cdot {Z}_{P n sensors}$$

$${C}_{b} ( α , β ) {=}^{def} \frac{\partial {C}^{T}}{\partial β} ( α , β )$$

$$C ( α , β ) = {[ \begin{matrix}{C}_{1} ( α , β ) \\ {C}_{2} ( α , β ) \\ {C}_{3} ( α , β ) \\ ⋮ \\ {C}_{M} ( α , β )\end{matrix} ]}_{M \times 1}$$

$${C}_{m} ( α , β ) = exp i ( {δ}_{m} ( α , β ) + {B}_{sensor m} ( σ ( α , β ) , γ ( α , β ) ) \\ {δ}_{m} ( α , β ) = {\vec{u}}_{sensors} ( α , b ) \cdot {\vec{r}}_{m sensors} \cdot ( 2 π / λ ) \\ {\vec{u}}_{sensors} ( α , β ) = [ \begin{matrix}α \\ β \\ \sqrt{1 - {α}^{2} - {β}^{2}}\end{matrix} ] = [ \begin{matrix}ux ( α , β ) \\ uy ( α , β ) \\ uz ( α , β )\end{matrix} ] \\ σ ( α , β ) = {tan}^{- 1} ( \sqrt{{α}^{2} + {β}^{2}} , \sqrt{1 - {α}^{2} + {β}^{2}} ) \\ γ ( α , β ) = {tan}^{- 1} ( α , β )$$

The slopes ρₐ and ρ_{b} are calculated in the following manner:

$$Π ( α , β ) {=}^{def} {C}^{T} ( α , β ) \cdot C ( {α}_{0} , {β}_{0} )$$

$${Δ}_{a} ( α , β ) {=}^{def} \frac{\partial {C}^{T}}{\partial α} ( α , β ) \cdot C ( {α}_{0} , {β}_{0} ) = \frac{\partial }{\partial α} ( Π ) ( α , β ) \\ {Δ}_{b} ( α , β ) {=}^{def} \frac{\partial {C}^{T}}{\partial σ} ( α , β ) \cdot C ( {α}_{0} , {β}_{0} ) = \frac{\partial }{\partial β} ( Π ) ( α , β ) \\ {ρ}_{S} {=}^{def} \frac{\partial }{\partial α} ( Re [ {Δ}_{a} \cdot Π ] ) ( {α}_{0} , {β}_{0} ) / ‖ {Π ( {α}_{0} , {β}_{0} ‖}^{2} \\ {ρ}_{A} {=}^{def} \frac{\partial }{\partial β} ( Re [ {Δ}_{b} \cdot Π ] ) ( {α}_{0} , {β}_{0} ) / ‖ {Π ( {α}_{0} , {β}_{0} ‖}^{2}$$

for values (α₀, β₀) corresponding to the latest estimated values of (α,β).

If the values of (α, β) are close to the true values (αₜᵣᵤₑ, βₜᵣᵤₑ):

D_{a n}(α,β)≅(α−α_{true n})+noise

D_{b n}(α,β)≅(β−β_{true n})+noise

An observational model is also used.

The relation between the direction cosines (αₙ,βₙ) and the Euler angles (ψ,θ,φ) is not linear.

$${\vec{u}}_{n sensors} ( ψ , θ , ϕ ) = [ \begin{matrix}{ux}_{n} ( ψ , θ , ϕ ) \\ {uy}_{n} ( ψ , θ , ϕ ) \\ {uz}_{n} ( ψ , θ , ϕ )\end{matrix} ] = [ \begin{matrix}{α}_{n} ( ψ , θ , ϕ ) \\ {β}_{n} ( ψ , θ , ϕ ) \\ \sqrt{1 - {{α}_{n} ( ψ , θ , ϕ )}^{2} - {β}_{n} ( ψ , θ , ϕ )}\end{matrix} ]$$

$${\vec{u}}_{n sensors} ( ψ , θ , ϕ ) = M ( ψ , θ , ϕ ) \cdot {\vec{u}}_{n TGL}$$

$$M ( ψ , θ , ϕ ) = [ \begin{matrix}1 & 0 & 0 \\ 0 & cos ϕ & - sin ϕ \\ 0 & sin ϕ & cos ϕ\end{matrix} ] [ \begin{matrix}cos θ & 0 & - sin θ \\ 0 & 1 & 0 \\ sin θ & 0 & cos θ\end{matrix} ] [ \begin{matrix}cos ψ & sin ψ & 0 \\ - sin ψ & cos ψ & 0 \\ 0 & 0 & 1\end{matrix} ]$$

This relationship is linearized about a point of operation (ψ,θ,φ) in order to establish a linear observational model:

$$d {α}_{n} {=}^{def} {α}_{n} ( ψ + d ψ , θ + d θ , ϕ + d ϕ ) - {α}_{n} ( ψ , θ , ϕ )$$

$$d {β}_{n} {=}^{def} {β}_{n} ( ψ + d ψ , θ + d θ , ϕ + d ϕ ) - {β}_{n} ( ψ , θ , ϕ )$$

$$d {α}_{n} = \frac{\partial {ux}_{n}}{\partial ψ} ( ψ , θ , ϕ ) \cdot d ψ + \frac{\partial {ux}_{n}}{\partial θ} ( ψ , θ , ϕ ) \cdot d θ + \frac{\partial {ux}_{n}}{\partial ϕ} ( ψ , θ , ϕ ) \cdot d ϕ$$

$$d {β}_{n} = \frac{\partial {uy}_{n}}{\partial ψ} ( ψ , θ , ϕ ) \cdot d ψ + \frac{\partial {uy}_{n}}{\partial θ} ( ψ , θ , ϕ ) \cdot d θ + \frac{\partial {uy}_{n}}{\partial ϕ} ( ψ , θ , ϕ ) \cdot d ϕ$$

For the calculation, partial derivatives can be used in the finite difference method:

$$\frac{\partial {ux}_{n}}{\partial ψ} ( ψ , θ , ϕ ) = ( \partial {ux}_{n} ( ψ + d ψ , θ , ϕ ) - \partial {ux}_{n} ( ψ , θ , ϕ ) ) / d ψ$$

Using Other Notations:

dαₙ=a_{n,1}·dψ+a_{n,2}·dθ+a_{n,3}·dφ

dβₙ=b_{n,1}·dψ+b_{n,2}·dθ+b_{n,3}·dφ

If all the visible satellites are taken into account, this results in 2·N equations for 3 unknowns.

$$[ \begin{matrix}d {α}_{1} \\ d {β}_{1} \\ ⋮ \\ d {α}_{N} \\ d {β}_{N}\end{matrix} ] = [ \begin{matrix}{a}_{1 , 1} & {a}_{1 , 2} & {a}_{1 , 3} \\ {b}_{1 , 2} & {b}_{1 , 2} & {b}_{1 , 3} \\ ⋮ & ⋮ & ⋮ \\ {a}_{N , 1} & {a}_{N , 2} & {a}_{N , 3} \\ {b}_{N , 1} & {b}_{N , 2} & {b}_{N , 3}\end{matrix} ] [ \begin{matrix}d ϕ \\ d θ \\ d ψ\end{matrix} ]$$

being:

$$[ \begin{matrix}d {α}_{1} \\ d {β}_{1} \\ ⋮ \\ d {α}_{N} \\ d {β}_{N}\end{matrix} ] = H [ \begin{matrix}d ϕ \\ d θ \\ d ψ\end{matrix} ] with H = [ \begin{matrix}{a}_{1 , 1} & {a}_{1 , 2} & {a}_{1 , 3} \\ {b}_{1 , 2} & {b}_{1 , 2} & {b}_{1 , 3} \\ ⋮ & ⋮ & ⋮ \\ {a}_{N , 1} & {a}_{N , 2} & {a}_{N , 3} \\ {b}_{N , 1} & {b}_{N , 2} & {b}_{N , 3}\end{matrix} ]$$

The idea is to get back to the errors on the Euler angles (dψ=ψ−ψₜᵣᵤₑ, dθ=θ−θₜᵣᵤₑ, dφ=φ−φₜᵣᵤₑ) starting from the errors on the direction cosines (dαₙ=αₙ(ψ,θ,φ)−α_{true n}, dβₙ=βₙ(ψ,θ,φ)−β_{true n})

The errors on the direction cosines are observable thanks to the discriminators:

dαₙ=αₙ(ψ,θ,φ)−α_{0 n}=D_{a n}(αₙ(ψ,θ,φ),βₙ(ψ,θ,φ))+noise

dβₙ=βₙ(ψ,θ,φ)−β_{0 n}=D_{b n}(αₙ(ψ,θ,φ),βₙ(ψ,θ,φ))+noise

A solution by least squares may also be used:

$$[ \begin{matrix}d {ϕ}_{estimated} \\ d {θ}_{estimated} \\ d {ψ}_{estimated}\end{matrix} ] = H * [ \begin{matrix}d {α}_{1} \\ d {β}_{1} \\ ⋮ \\ d {α}_{N} \\ d {β}_{N}\end{matrix} ]$$

with H*=(H^{T}W^{T}WH)⁻¹H^{T}W^{T} for pseudo-inverse.

The matrix W allows the measurements to be weighted as a function of the signal-to-noise ratio estimated on each satellite signal.

$$W = [ \begin{matrix}1 / {σ}_{a 1}^{2} & 0 & … & … & 0 \\ 0 & 1 / {σ}_{b 1}^{2} & … & … & ⋮ \\ ⋮ & … & … & … & ⋮ \\ ⋮ & & … & 1 / {σ}_{a N}^{2} & 0 \\ 0 & … & … & 0 & 1 / {σ}_{bN}^{2}\end{matrix} ]$$

$${σ}_{an}^{2} = {σ}_{bn}^{2} = \frac{1}{C / {N}_{0 estimated n}}$$

After the solution, the previously estimated Euler angles are corrected:

$$[ \begin{matrix}{ϕ}_{estimated} \\ {θ}_{estimated} \\ {ψ}_{estimated}\end{matrix} ] = [ \begin{matrix}{ϕ}_{previous estimate} \\ {θ}_{previous estimate} \\ {ψ}_{previous estimate}\end{matrix} ] + [ \begin{matrix}d {ϕ}_{estim {e}^{′} } \\ d {θ}_{estim {e}^{′} } \\ d {ψ}_{estim {e}^{′} }\end{matrix} ]$$

As a variant to the least squares, a solution by Kalman filter (extended) may be used, as follows:

State:

Real:

$${X}_{i} = [ \begin{matrix}{ϕ}_{i} \\ {θ}_{i} \\ {ψ}_{i}\end{matrix} ]$$

### Estimated:

$${X}_{i / i} = [ \begin{matrix}{ϕ}_{estim {e}^{′ } i} \\ {θ}_{estim {e}^{′} i} \\ {ψ}_{estim {e }^{′} i}\end{matrix} ]$$

at the time i

Initialization:

$${X}_{0 / 0} = [ \begin{matrix}{ϕ}_{initial estimate} \\ {θ}_{initial estimate} \\ {ψ}_{initial estimate}\end{matrix} ]$$

$${P}_{0 / 0} = [ \begin{matrix}∞ & 0 & 0 \\ 0 & ∞ & 0 \\ 0 & 0 & ∞\end{matrix} ]$$

Propagation:

X_{i/i-1}=X_{i-1/i-1} Propagated state vector

P_{i/i-1}=P_{i-1/i-1}+Qᵢ Propagated covariance matrix

$${Q}_{i} = [ \begin{matrix}{q}_{ϕ} & 0 & 0 \\ 0 & {q}_{θ} & 0 \\ 0 & 0 & {q}_{ψ}\end{matrix} ]$$

### State Noise

The state noise is chosen as a function of the dynamic behaviour on the attitude of the carrier.

Resetting:

$${Y}_{i} = [ \begin{matrix}d {α}_{1} \\ d {β}_{1} \\ ⋮ \\ d {α}_{N} \\ d {β}_{N}\end{matrix} ]$$

$${H}_{i} = [ \begin{matrix}{a}_{1 , 1} & {a}_{1 , 2} & {a}_{1 , 3} \\ {b}_{1 , 2} & {b}_{1 , 2} & {b}_{1 , 3} \\ ⋮ & ⋮ & ⋮ \\ {a}_{N , 1} & {a}_{N , 2} & {a}_{N , 3} \\ {b}_{N , 1} & {b}_{N , 2} & {b}_{N , 3}\end{matrix} ]$$

$${R}_{i} = [ \begin{matrix}{σ}_{a 1}^{2} & 0 & … & … & 0 \\ 0 & {σ}_{b 1}^{2} & ⋮ & & ⋮ \\ ⋮ & … & … & … & ⋮ \\ ⋮ & & … & {σ}_{aN}^{2} & 0 \\ 0 & … & … & 0 & {σ}_{bN}^{2}\end{matrix} ]$$

The innovation Yᵢ=Zᵢ−HX_{i/i-1} is already contained in the discriminators, so it is not necessary to recalculate it.

Kᵢ=(HᵢP_{i/i-1}Hᵢ^{T}+Rᵢ)⁻¹P_{i/i-1}Hᵢ^{T} Resetting gain

X_{i/i}=X_{i/i-1}+Kᵢ·Yᵢ Reset state vector

P_{i/i}=(Id−kᵢHᵢ)·P_{i/i-1} Reset covariance matrix

The schematic overview in FIG. 11 illustrates the above steps.

FIG. 12 illustrates a receiver 10 for signals from a satellite navigation system, equipped with an antenna 11 using controlled reception pattern sensors, comprising, for each satellite:
means 12 for calculating the position of the satellite in a first TGL reference frame centred on the receiver using the position of the receiver and the position of the satellite;
means 13 for determining the attitude of the antenna in the first reference frame;
means 14 for determining first elevation and azimuthal angles of the satellite in a second reference frame linked to the antenna, using the position of the satellite in the first reference frame and the attitude of the antenna in the first reference frame;
means 15 for determining second elevation and azimuthal angles of the satellite in the second reference frame, by iterative search for a maximum of a weighted complex sum of the demodulated signals received by the antenna;
means 16 for calculating the value of a likelihood function between the first elevation and azimuthal angles of the satellite and the second elevation and azimuthal angles of the satellite; and
means 17 for detecting a risk of receiving a decoy signal when the said value of the likelihood function is lower than a threshold.

Such a receiver implements the method previously described.

In the present application, the notations used have the definitions:

expi(φ)=exp(j·φ)=e^{jφ}(j²=−1)

### DEFINITIONS

Fᵣ: Residual frequency of the digitized signals in base band (Fᵣ small compared to Fe)

Dopₙ: Doppler shift on the satellite signal n

φ_{m,n}: Phase-shift of the satellite signal n on the sensor m

Cₙ(t): spreading code for the satellite n

Retₙ: delay of the satellite signal n

R(τ): Autocorrelation function for the code

R(τ)=1−|τ| if |τ|<1 R(τ=0)=1

R(τ)=0 otherwise

R_{n,n}(τ)=¹/_{L}∫_{[kL,(k+1)L]}Cₙ(u)·Cₙ(u+τ)du=R(τ) for large L(>1000) and for any value of k

R_{n,p}(τ)=¹/_{L}∫_{[kL,(k+1)L]}Cₙ(u)·Cₚ(u+τ)du≅0 if p≠n

### Signals Received:

The signal received on the antenna is the sum of the signals received from the visible satellites plus noise

S_{received m}(t)=Σ_{n=1, . . . ,N}S_{received m,n}(t)+noise

Signal Received from the Satellite n on the Sensor m:

S_{received m,n}(t)=A·expi(φ_{received carrier m,n}(t))·Cₙ(φ_{received code n}(t))

S_{received m,n}(t)=A·expi(2π·(Fᵣ+Dopₙ)·t+θ_{m,n})·Cₙ(F_{code}(t+Retₙ))

### Local Signal in the Channel n:

S_{local n}(t)=expi(−φ_{local carrier n}(t))·Cₙ(φ_{local code n}(t))

S_{local n}(t)=expi(−2π·(Fᵣ+Dopₙ)·t−θₙ)·Cₙ(F_{code}·(t+Retₙ)+τ)

### Correlations:

Z_{m,n}=¹/_{T}∫_{[kT,(k+1)T]}S_{received m}(t)·S_{local n}(t)dt

T: coherent integration time (typically T=20 ms)

Since the satellite codes are decorrelated (R_{n,p}(τ)≅0), the following may be written:

Z_{m,n}(k)=¹/_{T}∫_{[kT,(k+1)T]}S_{received m,n}(t)·S_{local n}(t)dt+noise

Z_{m,n}(k)=¹/_{T}∫_{[kT,(k+1)T]}expi(φ_{received port m,n}(t)−φ_{local port n}(t))·Cₙ(φ_{received code n}(t))·Cₙ(φ_{local code n}(t))dt

Z_{m,n}(k)=A·expi(θ_{m,n}−θₙ)·¹/_{L}∫_{[kL,(k+1)L]}Cₙ(u+τ)·Cₙ(u)du+noise

Z_{m,n}(k)=A·expi(θ_{m,n}−θₙ)·R(τ)+noise

It is assumed that the local code of the channel n is in phase with the code received from the satellite n, thanks to the delay-locked loop according to the prior art. This leads to τ=0 and R(τ)=1.

Z_{m,n}(k)=A·expi(θ_{m,n}−θₙ)+noise

1. Method for detecting signals intended as a decoy for a receiver of signals from a satellite navigation system, the receiver being equipped with an antenna using controlled reception pattern sensors, comprising the following steps consisting in, for each satellite:
calculating (1) the position of the satellite in a first TGL reference frame centred on the receiver based on the position of the receiver and on the position of the satellite;
determining (2) the attitude of the antenna in the first reference frame;
calculating (3) first elevation and azimuthal angles of the satellite in a second reference frame linked to the antenna, starting from the position of the satellite in the first reference frame and from the attitude of the antenna in the first reference frame;
determining (4) second elevation and azimuthal angles of the satellite in the second reference frame, by iterative search for a maximum of a weighted complex sum of the demodulated signals received by the antenna;
calculating (5) the value of a likelihood function between the first elevation and azimuthal angles of the satellite and the second elevation and azimuthal angles of the satellite; and
detecting (6) a risk of receiving decoy signals when the said value of the likelihood function is lower than a threshold.

2. Method according to either of claim 1, in which the step (2) for determining the attitude of the antenna in the first reference frame uses data supplied by an inertial reference.

3. Method according to claim 1, in which the step (2) for determining the attitude of the antenna in the first reference frame uses the said determination (4) of the second elevation and azimuthal angles of the satellites in the second reference frame and carries out an iterative search for the attitude angles of the antenna yielding the minimum of the likelihood function.

4. Method according to claim 1, in which the step (2) for determining the attitude of the antenna in the first reference frame carries out an iterative search for the attitude angles of the antenna yielding the maximum energy after the weighted sums at the output of the correlators of the processing channel respectively associated with the satellites.

5. Method according to claim 4, in which the said maximization uses a least squares solution method.

6. Method according to claim 5, in which direction cosine discriminators representative of the position of the satellites in the second reference frame linked to the antenna are used.

7. Method according to claim 6, in which a method based on an observational model of the relationship between the direction cosines of the directions of the satellites and the Euler angles of the directions of the satellites is used.

8. Method according to claim 4, in which the said maximization uses a method for solution by Kalman filtering.

9. Method according to claim 8, in which direction cosine discriminators representative of the position of the satellites in the second reference frame linked to the antenna are used.

10. Method according to claim 9, in which a method based on an observational model of the relationship between the direction cosines of the directions of the satellites and the Euler angles of the directions of the satellites is used.

11. Method according to claim 1, in which the said iterative search for a maximum of a weighted complex sum of the demodulated signals received by the antenna is carried out using an elevation angle discriminator and an azimuthal angle discriminator.

12. Method according to either of claim 11, in which the step (2) for determining the attitude of the antenna in the first reference frame uses data supplied by an inertial reference.

13. Method according to claim 11, in which the step (2) for determining the attitude of the antenna in the first reference frame uses the said determination (4) of the second elevation and azimuthal angles of the satellites in the second reference frame and carries out an iterative search for the attitude angles of the antenna yielding the minimum of the likelihood function.

14. Method according to claim 11, in which the step (2) for determining the attitude of the antenna in the first reference frame carries out an iterative search for the attitude angles of the antenna yielding the maximum energy after the weighted sums at the output of the correlators of the processing channel respectively associated with the satellites.

15. Method according to claim 14, in which the said maximization uses a least squares solution method.

16. Method according to claim 15, in which direction cosine discriminators representative of the position of the satellites in the second reference frame linked to the antenna are used.

17. Method according to claim 16, in which a method based on an observational model of the relationship between the direction cosines of the directions of the satellites and the Euler angles of the directions of the satellites is used.

18. Method according to claim 14, in which the said maximization uses a method for solution by Kalman filtering.

19. Method according to claim 18, in which direction cosine discriminators representative of the position of the satellites in the second reference frame linked to the antenna are used.

20. Method according to claim 19, in which a method based on an observational model of the relationship between the direction cosines of the directions of the satellites and the Euler angles of the directions of the satellites is used.

21. Receiver (10) of signals from a satellite navigation system, equipped with an antenna (11) using controlled reception pattern sensors, comprising, for each satellite:
means (12) for calculating the position of the satellite in a first TGL reference frame centred on the receiver using the position of the receiver and the position of the satellite;
means (13) for determining the attitude of the antenna in the first reference frame;
means (14) for determining first elevation and azimuthal angles of the satellite in a second reference frame linked to the antenna, starting from the position of the satellite in the first reference frame and from the attitude of the antenna in the first reference frame;
means (15) for determining second elevation and azimuthal angles of the satellite in the second reference frame, by iterative search for a maximum of a weighted complex sum of the demodulated signals received by the antenna;
means (16) for calculating the value of a likelihood function between the first elevation and azimuthal angles of the satellite and the second elevation and azimuthal angles of the satellite; and
means (17) for detecting a risk of receiving decoy signals when the said value of the likelihood function is lower than a threshold.
